(19) United States
(12) Patent Application Publication
(10) Pub. No.: US 2005/0284928 A1
(43) Pub. Date: Dec. 29, 2005

(54) Method and system for associating customer information with a customer identifier

(76) Inventor: Daniel C. Harrell, Round Rock, TX (US)

Correspondence Address: FISH & RICHARDSON P.C., P.O. BOX 1022, MINNEAPOLIS, MN, 55440-1022, US

(21) Appl. No.: 11/158,671

(22) Filed: Jun. 22, 2005

Related U.S. Application Data
(60) Provisional application No. 60/583,270, filed on Jun. 25, 2004.

(51) Int. Cl. G06K 5/00; H04K 1/00

(52) U.S. Cl. 235/380; 380/270

(57) ABSTRACT

A system for managing information relating to customers at a fuel service facility may include customer service points, one or more processors, a database, and a central server. The customer service points can receive a customer identifier, and the processors can apply a hash function to a customer identifier received by the customer service points to generate a system identifier. The database can store system identifiers, each associated with one or more customer preferences. The central server can associate one or more of the customer preferences with one or more of the system identifiers, store the associated customer preferences in the database, and provide access to the database.

### CLAIM OF PRIORITY

This application claims priority under 35 U.S.C. §119(e) to U.S. Provisional Application No. 60/583,270, filed Jun. 25, 2004, which is incorporated herein by reference for any and all purposes.

### TECHNICAL FIELD

This disclosure relates to customer information, and more particularly to a method and system for securely associating customer information with a customer identifier.

### BACKGROUND

It is advantageous for businesses to be able to respond to customer needs and to customize services accordingly, particularly in situations in which customers may be pressed for time. In such situations, the customer may not have time to deal with requests for information, which impedes the ability of the business to anticipate and respond to the customer's needs. One example of an industry plagued by these problems is the fuel-service industry, since fuel-service customers often spend a short amount of time refueling and purchasing other products. Techniques such as automatic collection of information from consumers about their purchasing habits provide one way of quickly and accurately collecting customer information, but there is a risk that confidential information used to identify consumers may be inadvertently disclosed to third parties, thus violating the customers' security and privacy. Consequently, it is desirable to have a method and system for associating customer information with a customer identifier.

### SUMMARY

In a particular embodiment, a system for managing information relating to customers at a fuel service facility includes customer service points, one or more processors, a database, and a central server. Each of the customer service points can receive a customer identifier. The processors apply a hash function to customer identifiers received by the customer service points to generate system identifiers. The database stores system identifiers, each associated with one or more customer preferences. The central server associates one or more of the customer preferences with one or more of the system identifiers, stores the associated customer preferences in the database, and provides access to the database.

In another embodiment, a fuel dispenser includes an input module, a processor, and an interface. The input module can receive a customer identifier, and the processor can apply a hash function to the customer identifier to generate a system identifier. The interface can send the system identifier to at least one other device.

In another embodiment, a method includes receiving a customer identifier at a customer service point. The method further includes generating a system identifier from the customer identifier using a hash function. The method also includes associating one or more customer preferences with the system identifier.

In yet another embodiment, a method includes receiving a customer identifier. The method further includes generating a system identifier from the customer identifier using a hash function. The method also includes providing access to one or more stored customer preferences associated with the system identifier.

In still another embodiment, a system includes customer service points, a database, and one or more processors. Each customer service point can receive a customer identifier, and the database can store system identifiers, each associated with one or more customer preferences. The system identifiers can be generated by applying a hash function to one of the customer identifiers. The processors can retrieve one or more stored customer preferences by applying the hash function to a particular customer identifier received by one of the customer service points.

Technical features of certain embodiments of the present invention include increased security. When system identifiers are produced using a substantially one-way hashing function, it is difficult, if not impossible, to retrieve the original customer information based on the system identifiers. Thus, the risk that the customers' security or privacy will be violated if the security of a database or communication protocol is compromised is greatly reduced.

Another technical feature of certain embodiments of the present invention is distributed storage. Customer preferences may be maintained locally at service stations and other customer service facilities, allowing information about a customer's preferences to be retrieved quickly at locations frequently visited by the customer. On the other hand, networking the various customer service facilities and/or providing additional central storage for customer information allows the information to be accessible when the customer travels to other service stations.

Yet another technical feature of certain embodiments of the present invention is a customized service experience. As information for a particular customer is collected, the service provider may provide services tailored to the customer's preferences. For example, a fuel dispenser could automatically apply the customer's preferences regarding language for displays, preferred grade of fuel, and the like. Similarly, the fuel dispenser could display customized advertising based upon previous information about the customer's purchasing habits.

Still another technical feature of certain embodiments of the present invention is the use of web interfaces to customize the user's experience. Frequently, the interactive displays at fuel dispensers and similar customer service devices are somewhat limited in their ability to receive information from a customer. By allowing another method of information input to customer profiles, such as a web interface, certain embodiments of the present invention increase the ability of the customer information system to collect and store information from consumers. Moreover, such alternative methods of information input provide a method for collecting information from consumers even when they are not present at a service station. This in turn allows customers to provide information without the common time constraints associated with purchasing activities such as refueling a vehicle.

Although particular technical features have been enumerated, particular embodiments may have some, all, or none of the enumerated technical features. The details of one or more illustrative embodiments of the invention are set forth in the accompanying drawings and the description below. Other features of the invention will be apparent from the description and drawings, and from the claims.

### DESCRIPTION OF DRAWINGS

FIG. 1 illustrates a system that collects information from customers, generates a system identifier from a customer identifier, and associates the system identifier with customer preferences in a database;

FIG. 2 illustrates an example of a service facility in the system of FIG. 1;

FIG. 3 illustrates an example of a table to associate customer preferences with a system identifier;

FIGS. 4A and 4B illustrate an example of a method of operation for the system of FIG. 1; and

FIG. 5 illustrates an example of a method for modifying customer preferences at a central database.

Like reference symbols in the various drawings indicate like elements.

### DETAILED DESCRIPTION

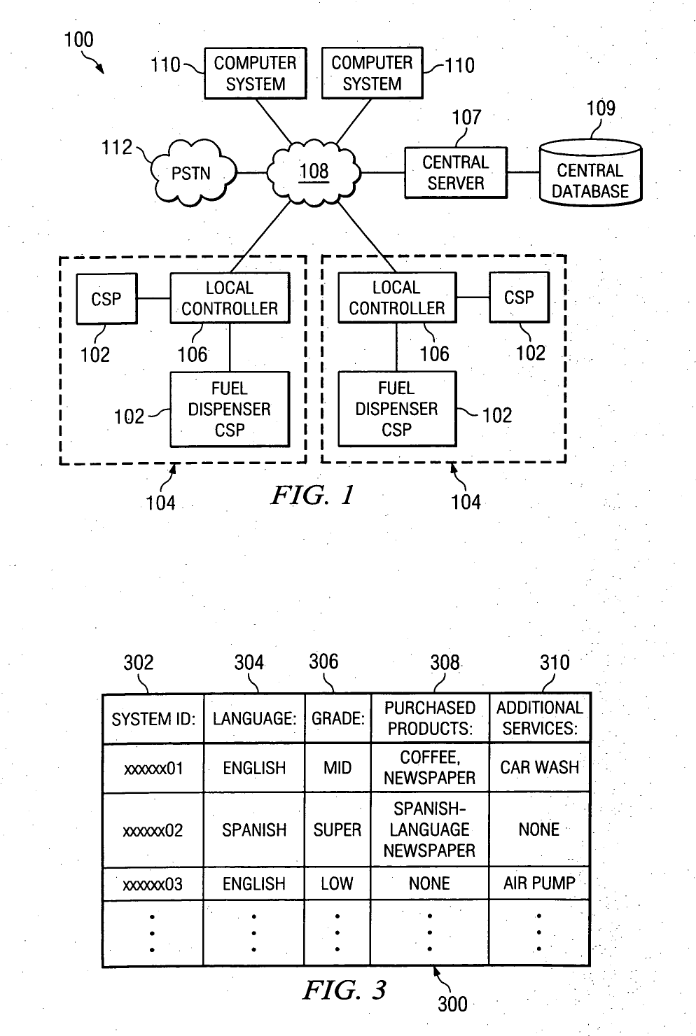

FIG. 1 is a system 100 that collects information from customers at a variety of customer service points (CSPs) 102, generates a system identifier based on a customer identifier, and maintains a database of customer information that associates the system identifier with the customer's preferences. In particular, system 100 may generate the system identifier using a one-way hash function, so that it is difficult or impossible to determine the customer identifier from the system identifier. In the depicted embodiment, system 100 includes a variety of service facilities 104 each having one or more CSPs 102. CSPs 102 at each service facility 104 communicate with a local controller 106 associated with that service facility 104. Local controllers 106 in turn communicate with a network 108 that allows communication between local controllers 106 and a central server 107 maintaining a central database 109. Network 108 may also allow communication with one or more additional computer systems 110 that provide additional services.

CSPs 102 may include any device for dispensing products and/or services to customers based upon customer preferences. For example, CSPs may include fuel dispensers, automated teller machines (ATMs), cash registers, vending machines, other similar devices, or any combinations of these and other devices. CSPs 102 may respond to a variety of customer preferences, such as selections of a particular language, fuel grade, or service package. Moreover, CSPs 102 may provide information to a customer. This is particularly valuable in the case of advertisements, when tailoring the advertisement to the customer's preferences (also known as “targeted marketing”) is often much more effective than simply displaying untargeted advertising.

Service facilities 104 are locations that provide products and services at one or more CSPs 102. For example, service facilities 104 may be service stations, stores, or other types of businesses. In the depicted embodiment, each service facility includes a respective local controller 106, but it should be understood that service facilities 104 may include additional local controllers 106 as well. Local controller 106 may be any manner of computing device, such as a personal computer, a server, or a microprocessor. Local controllers 106 exchange information with CSPs 102 in order to coordinate the collection of information from customers and the communication of stored information to CSPs 102. For example, local controllers 106 could receive customer information collected by CSP 102 that may be stored or used to retrieve previously stored information. In another example, local controllers 106 may communicate retrieved information about a particular customer to a particular CSP 102 that is providing services to that customer.

Network 108 is any component or collection of components allowing communication between local controllers 106 and/or central database 109. Network 108 may include routers, hubs, switches, gateways, or any other suitable communication components. Network 108 may use one or more communication media, which may include techniques such as wireline, wireless, or optical communication, and may communicate using one or more communication protocols, such as transport control protocol/Internet protocol (TCP/IP), Ethernet, IEEE 802.11, time division multiplexing (TDM), asynchronous transfer mode (ATM), or synchronous optical network (SONET). In particular embodiments, network 108 allows communication with the public switched telephone network (PSTN) 112, which may involve one or more communication gateways (not shown). Network 108 may also communicate with computer systems 110, which may include any manner of information-processing device able to exchange information with one or more local controllers 106. One example of such a computer system 110 is the computer system of a credit card company that handles approval of credit card transactions and generates alerts when a stolen credit card is used. Another example of a computer system 100 is a personal computer that may be used by a customer to access and modify customer preferences stored in central database 109.

Central server 107 represents any collection of hardware and/or software that maintains central database 109 of customer information. Central server 107 is accessible by local controllers 106 and/computer systems 110 in order to receive updated information about customer preferences and to provide retrieved customer information stored in central database 109. Central server 107 may include any manner of information-processing circuitry or software programs that are useful in information storage or retrieval, and central database 109 may use any form of storage medium, including such forms of memory as magnetic media, optical media, and removable media, organized in any suitably accessible form.

Overall, system 100 may store customer information centrally, locally, or in a combination of central and local storage, and local controllers 106 may act independently or in concert with one another. Thus, there may be a variety of different embodiments of system 100, including distributed architectures of intercommunicating local controllers 106, centralized architectures in which local controllers 106 all maintain a common store of information at central database 109, combined architectures allowing the use of both local and central information storage as needed, or any other suitable architecture for distributing functions relating to the storage of customer information among one or more components of system 100. Although particular embodiments of system 100 may be described using one or more of these architectures, it should be understood that such descriptions may be suitably modified for use in other architectures.

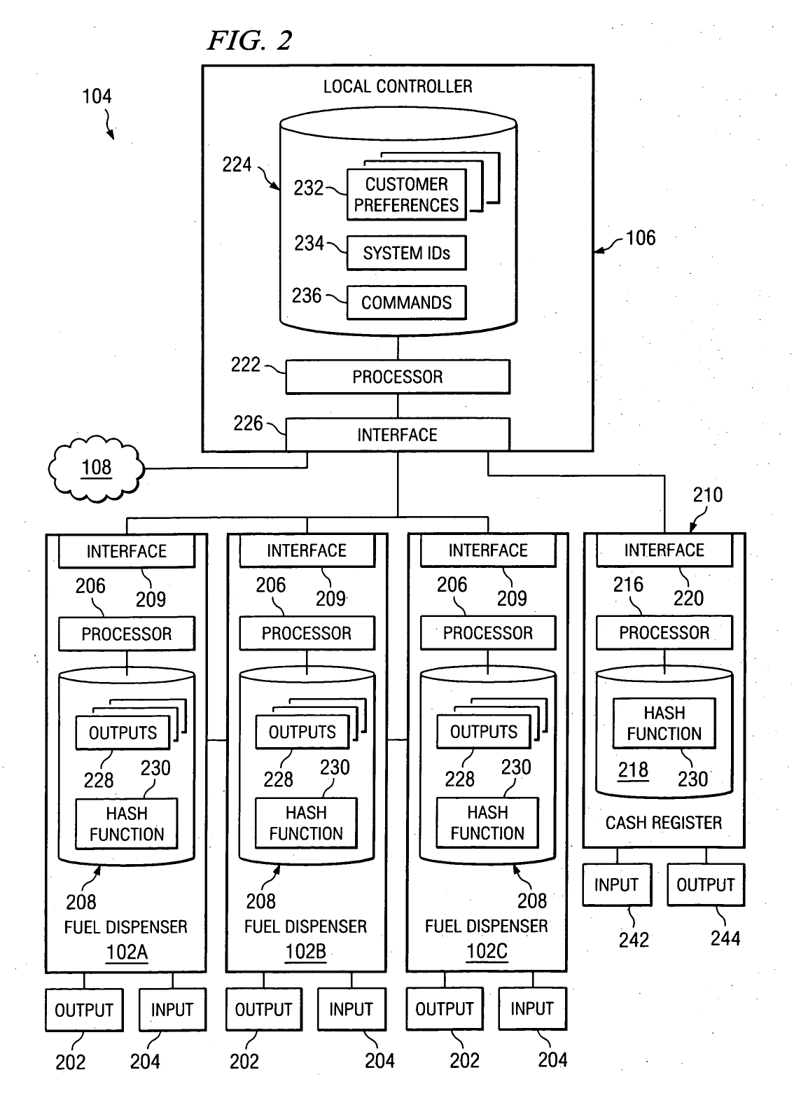

In operation, system 100 collects information from customers, generates system identifiers from customer identifiers, and maintains customer information associated with each system identifier in a database. Some examples of customer identifiers include credit card numbers, ATM card numbers, personal identification numbers (PINs), telephone numbers, radio frequency identifiers (RFID) numbers, loyalty card numbers, driver's license numbers, government ID numbers, any other suitable form of identification, or any portion or combination of such forms of identification. The corresponding system identifier for the customer identifier is generated using a hash function, the operation of which will be described in greater detail below in conjunction with FIG. 2. Different CSPs 102 and/or service facilities 104 may use the same hash function, so that the system identifier generated from a particular customer identifier is the same among the CSPs 102, service facilities 104, and/or local controllers 106 of system 100. The customer's preferences are then accessible by other local controllers 106 using the same hash function, so that information relating to a customer frequently visiting one service facility 104 is retrievable at other service facilities 104.

The customer information associated with each customer identifier may include any type of customer preference that may be used to customize the customer's experience and/or to improve the ability of service facility 104 to deliver products and services to meet the customer's needs. For example, a fuel dispenser may require one or more customer settings, such as fuel grade, a language for the fuel dispenser display, audio settings, video settings, or selection of optional services (e.g., car wash, air pump, water hose). The customer information could record the customer's preferences and previous history, and based on that information, the fuel dispenser could automatically set certain options or to provide additional options. Furthermore, the fuel dispenser could use information from other transactions to customize the fuel dispenser experience as well. An example of such a customized experience would be the use of targeted advertising on the fuel dispenser display based on the customer's purchasing habits in a convenience store. Of course, the collection and use of customer information need not be limited to fuel dispensers; similar customization, including automatically setting user options and providing targeted advertising, may be employed in all manner of CSPs 102.

The features of particular embodiments may be further described with reference to the service facility 104 depicted in FIG. 2. The depicted embodiment of service facility 104 includes fuel dispensers 200A, 200B, and 200C (collectively referred to as “dispensers 200”), a cash register 210, and a local controller 106. Fuel dispenser 200A is shown in greater detail and includes an output module 202 (such as a display), an input module 204, a processor 206, a memory module 208, and a device interface 209. Cash register 210 includes an input module 212, an output module 214, a processor 216, a memory module 218, and a device interface 220. Local controller 106 includes a processor 222, a memory module 224, and an interface 226. Processors 206, 216, and 222 may include any component or components for processing information, including microprocessors, microcontrollers, digital signal processors (DSPs) or other suitable components. Memory modules 208, 218, and 224 may include any form of information storage, whether local or remote, such as magnetic media, optical media, and numerous other fixed or removable media.

Dispensers 200 receive information from customers using respective input modules 204. Input modules 204 may include keypads, touch screens, card scanners, radio frequency identification (RFID) readers, hardware for use in voice recognition, or any other numerous components for receiving information from customers. In particular, dispenser 200 collects some form of customer identifier from customers. Dispensers 200 provide information to customers using output module 202, which may be a video screen, speakers, printers, or any other suitable components for outputting information to customers. Information to be output using output module 202 may be stored in memory module 208, as illustrated by stored outputs 228. Stored outputs 228 may be, for example, recorded messages or advertisements, electronic coupons, access numbers for special offers, or other similar information provided for the customer's use. Dispenser 200 may selectively choose from among stored outputs 228 in order to customize the dispenser experience for a customer.

Dispenser 200 also maintains a hash function 230 in memory module 208, or alternatively, in another suitably accessible location. Hash function 208 is a mathematical algorithm that generates a system identifier from a customer identifier received using input module 204. The customer identifier provided to hash function 208 is sometimes known as a “hash key,” while the output may be referred to as a “hashed value.” It is desirable, although not strictly necessary, for hash function 208 to be collision-free within the range of possible customer identifiers. This allows a unique system identifier to be associated with each unique customer identifier, so that database entries associated with a system identifier will not be accidentally associated with multiple customers. For security reasons, it is desirable for hash function 208 to be one-way, meaning that it is difficult to analyze a set of system identifiers to determine the original hash values or perhaps completely impossible depending on the set of identifiers that is available. Thus, even if a relatively large set of system identifiers were to be obtained, it would likely be difficult or impossible to attempt to reconstruct the original customer identifiers. Some examples of hash functions that may be used either alone or in combination with one another include the division-remainder method (dividing the hash key by a certain divisor value and taking the remainder as the hashed value), folding (breaking the digits of the hash key into several portions, adding them together, and selecting a number of digits from the sum to serve as the hashed value), radix transformation (changing the number to a different number base), or digit rearrangement. Other hash functions, commonly used in the digital signature context to generate a hashed “message digest” value from a digital signature, include MD2, MD4, MD5, and the Secure Hashing Algorithm (SHA).

Dispenser 200 communicates with local controller 106 using device interface 209. Device interface 209 may be any suitable port or connection for exchanging information with local controller 106 and may use any communication medium (e.g., wireless, wireline, optical) using any suitable communication protocol. In particular, device interface 209 may be used to communicate customer selections, such as language, fuel grade, and additional services, to local controller 106. Device interface 209 may also receive commands from local controller 106, such as instructions to display a particular stored output 228.

Cash register 210 includes several components that are analogous to those of dispensers 102. These components may also adapted to receive and display information from an operator in place of or in addition to a customer. For example, input module 212 of cash register 210 may include a keypad for the operator and a card scanner for use by the customer. Similarly, output module 214 may include separate displays for the operator and the customer. Cash register 210 uses device interface 220 to communicate customer preferences, such as the products purchased by the consumer, to local controller 106. Cash register 210 may also use device interface 220 to receive commands from local controller 106. Thus, for example, local controller 106 could instruct cash register 210 to print a particular coupon for the customer.

Local controller 106 manages the maintenance and use of customer information, which may be stored locally or elsewhere, such as in central database 109. In particular, local controller 106 stores customer preferences 232 received from dispensers 102 and cash register 210. Customer preferences 232 are associated with system identifiers 234 generated by hash function 230, which allows the preference information to be associated with particular customers with relatively little risk to the customer's privacy. Although they are shown as being stored locally, it should be understood that customer preferences 232 may be stored remotely as well. Local controller 106 also stores a set of commands 236 for controlling the operation of dispensers 102 and cash register 210, which may be communicated to those devices using interface 226. Interface 226 represents any port or connection, using any suitable communication medium or communication protocol. Commands 236 are instructions for customizing the customer's experience at a particular customer service point. For example, commands 236 may instruct dispensers 200 or cash registers 210 to produce a particular output on their respective output modules 202 and 214, to apply a discount, or to customize the service experience in any other suitable way. Local controller 106 also communicates with network 108 using interface 226.

In operation, when a customer makes use of a CSP 102 (either dispensers 200 or cash register 210 in the depicted embodiment), CSP 102 collects a customer identifier from the customer and generates a system identifier from the customer identifier using hash function 230. Local controller 106 receives the system identifier and compares the system identifier to stored system identifiers 234 to determine whether there are stored customer preferences 232 associated with the received system identifier. Local controller 106 may also contact central server 107 to determine whether customer information associated with the system identifier is stored in central database 109. If there are customer preferences stored either locally or centrally, local controller 106 may issue commands 236 to the appropriate CSP 102 in order to provide a customized service experience to the customer. Local controller 106 may also collect new customer preferences or modify stored customer preferences 232 based on the use of CSP 102 by the customer. For example, local controller 106 may update stored customer preferences 232 if the customer modifies one or more settings. In another example, local controller 106 may provide a preference setup menu to new customers allowing the customer to select from several preference options. After a new or modified set of customer preferences is collected and stored, local controller 106 may communicate the updated customer preferences to central server 107 using network 108.

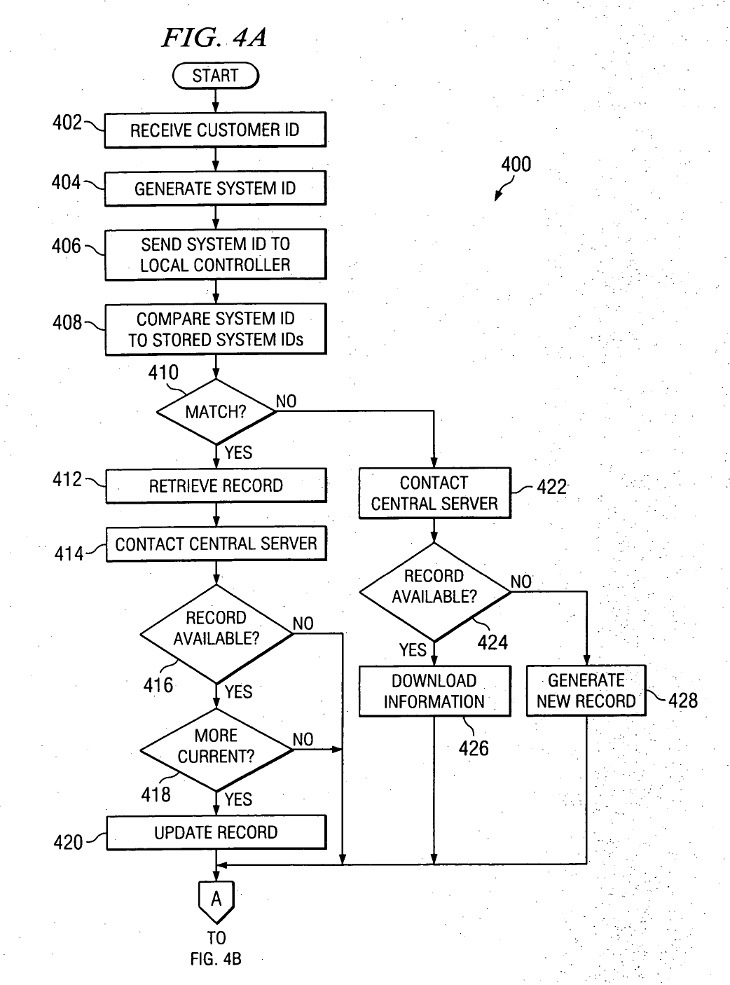

FIG. 3 illustrates one example of a table 300 that may be used to organize customer preferences and associate customer preferences with a system identifier. In the depicted embodiment, system identifiers 302 are each associated with four customer preferences. Language 304 is the customer's preferred language for displays. Grade 306 refers to the fuel grade selected by the customer. Purchased products 308 tracks products purchased by the customer at service facility 104. Particular examples, such as coffee and newspapers, have been provided, although numerous other products are contemplated. Additional services 310 refers to services requested by the customer in addition to the provision of fuel, which may include the use of car washes and air pumps or numerous other types of services. The particular form of table 300 and the particular set of customer preferences are only examples, and any other suitable customer information organized in a suitable form, such as a table or database, may be employed in addition to or instead of table 300.

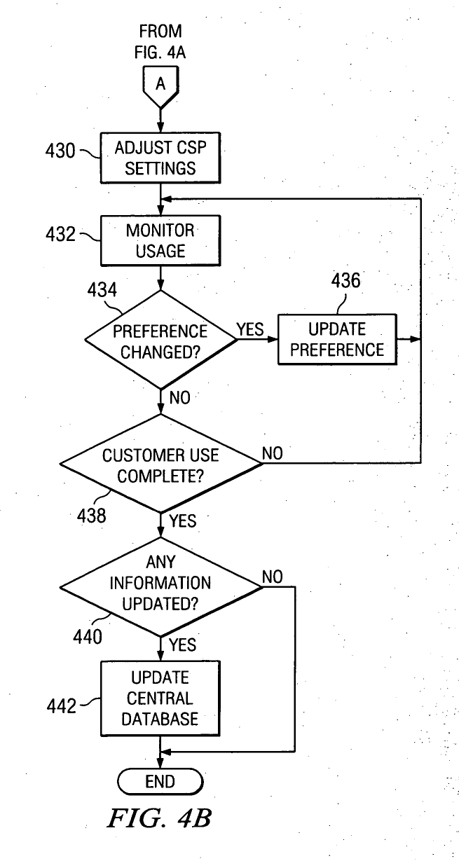

FIGS. 4A and 4B depict a flow chart 400 that illustrates an example method of operation for system 100. At step 402, CSP 102 receives a customer identifier. CSP 102 generates a system identifier from the customer identifier at step 404. CSP 102 then communicates the system identifier to local controller 106 at step 406. Upon receiving the system identifier, local controller 106 compares the system identifier to stored system identifiers 234 at step 408. Based on this comparison, local controller 106 determines whether the system identifier matches any stored system identifiers at step 410.

If there is a match with a stored system identifier 234, local controller 106 retrieves the associated customer preferences at step 412. Local controller 106 may also or alternately contact central server 107 at step 414 and determine whether central server 107 is maintaining a record in database 109 associated with the system identifier at step 416. If a record is present in central database 109, local controller 106 may determine whether the centrally maintained record is more current than the locally-maintained record. For example, local controller 106 may compare timestamp information for the records. If the record maintained at central database 109 is more current then the locally-maintained record, local controller 106 may appropriately update the local record.

If the received system identifier does not match any stored system identifiers 234 at local controller 106, local controller 106 contacts central server 107 at step 422 and determines whether there are any customer preferences associated with the system identifier in central database 109. If there is such a record, then local controller 106 downloads the set of customer preferences from central server 107 at step 426. Otherwise, local controller 106 generates a new record at step 428.

Once a set of customer preferences is retrieved or a new record is generated, local controller 430 sets CSP 102 based on the customer preferences at step 430. This may involve automatically setting certain options of CSP 102, providing particular advertising, or other similar adjustments to customize the service experience. The customer then proceeds to operate CSP 102. During operation, local controller 106 may monitor the customer's use of CSP 102 at step 432. If any changes in the customer's preferences are detected, either because the customer had adjusted a setting or because the customer has made a new selection, local controller 106 may update the record of the customer's preferences accordingly at step 436. This process may be repeated until the customer has completed use of CSP 102, as shown by decision step 438.

Once the customer's use of CSP 102 has ended, local controller 106 may determine whether any of the customer's preferences have been updated at step 440. If the customer's preferences have been updated, then local controller 106 may contact central server 107 at step 442 in order to provide the updated information to central database 109. After any updated information has been provided to central server 107, the method is at an end.

In addition to the operations described previously, particular embodiments of system 100 may allow customers to access and update customer preferences directly using communication methods such as telephones or the Internet. There are a variety of ways that customers might be associated with particular records. One method would be to provide the customer with a password associated with his system identifier. Such a password could be displayed on a screen, printed out on a receipt, or otherwise delivered to the customer. Another method would be to receive the appropriate customer identifier and to apply the hash function used to generate system identifiers in order to reproduce the system identifier. This has the advantage of being able to associate records with one another even when different customer identifiers (such as different credit cards) are used at a particular CSP 102. But if hashed customer identifiers are used to access central database 109, it is desirable for the customer identifiers to be received securely and discarded as soon as the system identifier is generated so that the security of the customer identifiers is not compromised.

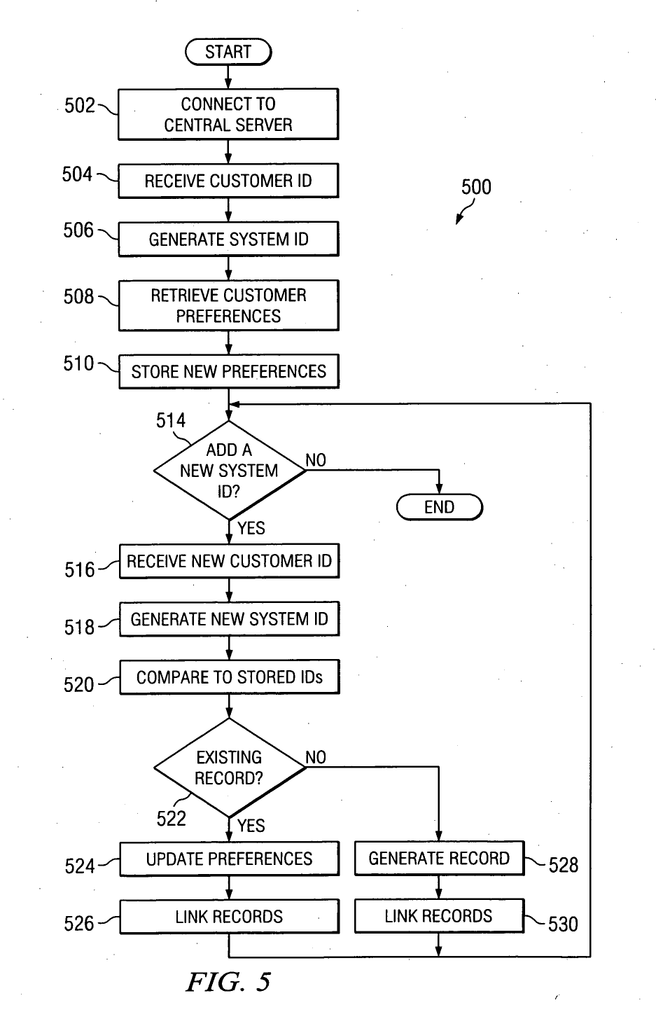

FIG. 5 is a flow chart 500 that illustrates an example method for updating customer preferences using the Internet. The customer connects to central server 107 at step 502. The customer then provides a customer identifier at step 504. Central server 107 generates a system identifier based on the customer identifier at step 506. Based on the system identifier, central server 107 retrieves a set of customer preferences from central database 109 at step 508. Central server 107 receives updated customer preferences at step 510 and stores the updated preferences in central database 109 at step 512.

The customer can also associate other system identifiers with his set of customer preferences. If the customer wishes to link a new system identifier to existing preferences (from decision step 514), the customer enters a new customer identifier, which is received by central server 107 at step 516. Central server 107 generates a system identifier for the new customer identifier at step 518 and compares the new customer identifier to stored customer identifiers at step 520. If there is an existing record corresponding to the new system identifier at decision step 522, then central server 107 updates the customer preferences associated with that identifier at step 524 to match the preferences that the customer entered previously at step 510. Central server 107 also links the record for the new system identifier to the record for the original system identifier at step 526, so that the two identifiers share a common set of customer preferences. If there is no existing record at decision step 522, central server 107 generates a new record associated with the new system identifier at step 528 and links the new record to the record for the original system identifier at step 530. The method then returns to decision step 514, allowing the customer to continue adding new identifiers. Once the customer is finished with adding new identifiers, the method is at an end.

A number of embodiments of the invention have been described. Nevertheless, it will be understood that various modifications may be made without departing from the spirit and scope of the invention. For example, other embodiments could address numerous other types of customer service points, customer preferences, and methods for responding to those preferences. Accordingly, other embodiments are within the scope of the following claims.

1. A fuel dispenser, comprising:
an input module operable to receive a customer identifier;
a processor operable to apply a hash function to the customer identifier to generate a system identifier; and
an interface operable to send the system identifier to at least one other device.

2. The fuel dispenser of claim 1, wherein the customer identifier comprises at least one of a credit card number, a telephone number, a loyalty card number, or a driver's license number.

3. The fuel dispenser of claim 1, wherein:
the system identifier is associated with one or more customer preferences; and
the set of customer preferences comprises at least one of a fuel grade, a language preference, a previously-purchased product, or a vehicle-related service.

4. The fuel dispenser of claim 3, wherein the vehicle-related service comprises at least one of washing a car, supplying air, or supplying water.

5. The fuel dispenser of claim 1, wherein the interface is further operable to receive one or more commands in response to sending the system identifier.

6. The fuel dispenser of claim 5, wherein at least one of the commands comprises at least one setting for the fuel dispenser.

7. The fuel dispenser of claim 5, wherein at least one of the commands comprises at least one selected advertising display.

8. The fuel dispenser of claim 7, wherein the fuel dispenser further comprises a memory module, and the selected advertising display is one of a plurality of advertising displays stored in the memory module.

9. The fuel dispenser of claim 1, wherein:
the input module is further operable to receive one or more settings for the fuel dispenser; and
the interface is further operable to send the settings for the fuel dispenser to at least one other device.

10. The fuel dispenser of claim 1, wherein the hash function comprises at least one of a one-way message digest function or a one-way secure hashing algorithm.

11. A method comprising:
receiving a customer identifier at a customer service point;
generating a system identifier from the customer identifier using a hash function; and
associating one or more customer preferences with the system identifier.

12. The method of claim 11, wherein the customer service point is a fuel dispenser.

13. The method of claim 11, further comprising:
monitoring a customer's use of the customer service point; and
storing one or more customer preferences based on the customer's use of the customer service point.

14. The method of claim 11, further comprising automatically adjusting at least one setting of the customer service point based on at least one associated customer preference.

15. The method of claim 11, further comprising:
selecting an advertising display based on at least one associated customer preference; and
displaying the selected advertising display at the customer service point.

16. The method of claim 11, further comprising:
monitoring a customer's use of the customer service point; and
modifying at least one associated customer preference based on the customer's use of the customer service point.

17. The method of claim 11, further comprising displaying a password associated with the system identifier on a display of the customer service point, wherein the password provides access to a database storing at least one associated customer preference.

18. A system, comprising:
a plurality of customer service points, the customer service points operable to receive a customer identifier;
a database storing a plurality of system identifiers, each system identifier associated with one or more customer preferences, wherein a system identifier is generated by applying a hash function to a customer identifier; and
one or more processors operable to retrieve one or more stored customer preferences by applying the hash function to a particular customer identifier received by one of the customer service points.

19. The system of claim 18, further comprising a central server operable to associate one or more of the customer preferences with one or more of the system identifiers, to store the associated customer preferences in the database, and to provide access to the database.

20. The system of claim 19, wherein the central server provides access to the database in response to receiving a password.

21. The system of claim 18, wherein the one or more processors are further operable to modify at least one of the stored customer preferences in response to a determination that the customer preferences have changed.

22. The system of claim 18, wherein the one or more processors are further operable in adjusting settings of the customer service points based on at least one of the customer preferences.

23. The system of claim 18, wherein the one or more processors are further operable in causing the customer service points to display one or more advertising displays based on at least one of the customer preferences.

24. The system of claim 18, wherein the customer service points are further operable to display a password providing access to at least one of the stored customer preferences.
